(19) United States
(12) Patent Application Publication
(10) Pub. No.: US 2003/0089006 A1
(43) Pub. Date: May 15, 2003

(54) Liquid-containing ornament

(76) Inventor: Vincent Kuo-Wei Lee, Taipei (TW)

Correspondence Address: DOUGHERTY & TROXELL, ATTORNEYS AT LAW, Suite 1404, 5205 Leesburg Pike, Falls Church, VA, 22041, US

(21) Appl. No.: 09/986,553

(22) Filed: Nov. 9, 2001

(51) Int. Cl. G09F 19/00

(52) U.S. Cl. 40/426

(57) ABSTRACT

A liquid-containing ornament includes a container containing one single type of liquid or two types of mutually indissoluble liquids having different densities and colors. The liquid flows down from the container into a chamber below the container via a low liquid outlet. A set of rotating blades having magnets attached on one side of the blades is mounted in the chamber, and a rotary disc driven to rotate by a motor and having magnets attached thereto is located outside the chamber corresponding to the set of rotating blades. When the rotary disc is rotated, it magnetically rotates the set of rotating blades to drive the liquid in the chamber into the container via a high liquid inlet, so that the liquid circulates in the container. Different decorations are provided in the container along a path of the circulating liquid flow to create changeful and dynamic scenes.

### BACKGROUND OF THE INVENTION

The present invention relates to a liquid-containing ornament, and more particularly to an ornament having a container for accommodating an amount of liquid therein, a chamber located below the container for accommodating a set of magnet-loaded rotating blades, and a magnet-loaded rotary disc located outside the chamber corresponding to the set of rotating blades. When the rotary disc is rotated by a motor, it magnetically rotates the set of rotating blades, so that the liquid flowing from the container into the chamber via a liquid outlet is driven by the set of rotating blades into the container again via a liquid inlet, allowing the liquid to circulate in the ornament. Different decorations are provided in the container along a path of the circulating liquid to create dynamic scenes in the container.

Ornaments with colored liquids are widely welcomed among general consumers. U.S. Pat. No. 6,023,394 B1 entitled Ornamental Liquid Color Box granted to the same applicant of the present invention discloses a liquid ornament having a driving mechanism that is shown in FIG. 6 of U.S. Pat. No. 6,023,394 B1 and FIG. 1 of the specification of the present invention. The driving mechanism employs a motor P1 having a driving gear P2 connected to a rotating shaft thereof. The driving gear P2 meshes with and therefore drives a driven gear P3 to rotate at the same time. The gears P2, P3 are provided on their top surfaces with a plurality of magnets P4. The two gears P2, P3 are separately located below two closely adjacent liquid-delivery spaces P5 to magnetically rotate two propellers P6 mounted in the two spaces P5, so that liquid contained in the ornament is continuously propelled upward in two parallel liquid boxes. With this type of driving mechanism, two upper liquid storing spaces P7 must be provided in the two liquid boxes and therefore forms a limit in designing the liquid ornaments.

### SUMMARY OF THE INVENTION

It is therefore a primary object of the present invention to provide a liquid-containing ornament that includes a structure and a driving mechanism permitting liquid to enter a liquid container via an inlet at a high position in the container and to flow down along a path winding among internal decorations provided in the liquid container to enter a chamber below the container and having the driving mechanism mounted therein, so that a variety of dynamic scenes could be created in the ornament and the conventional upper liquid storing spaces, such as that provided in the conventional liquid color box, could be omitted while the container is not necessarily a closed container.

To achieve the above object, the liquid-containing ornament of the present invention mainly includes a container containing one single type of liquid or two types of mutually indissoluble liquids having different densities and colors. The container is provided at a bottom surface with a liquid outlet tube having a low outlet and a liquid inlet tube having a high inlet to communicate with a chamber located below it via the outlet and inlet. A set of rotating blades having magnets attached on one side of the blades is mounted in the chamber, and a rotary disc driven to rotate by a motor and having magnets attached thereto is located outside the chamber corresponding to the set of rotating blades. When the rotary disc is rotated, it magnetically rotates the set of rotating blades. A first type of the two liquids having a higher density in the container automatically flows down into the chamber via the low outlet and is driven into the container via the liquid inlet tube by the set of rotating blades rotated by the rotary disc, forming a liquid flow circulating in the ornament. Different decorations are provided in the container along a path of the circulating liquid flow to create changeful and dynamic scenes.

The chamber and the rotating blades mounted in the chamber may be horizontally or vertically positioned, and the motor and the rotary disc may accordingly horizontally or vertically rotate corresponding to the exact position of the chamber and the rotating blades, allowing spatial changes in the base of the ornament.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view showing a driving mechanism disclosed in U.S. Pat. No. 6,203,394 B1 entitled Ornamental Liquid Color Box;

FIG. 2 is an assembled perspective view of a liquid-containing ornament according to a first embodiment of the present invention;

FIG. 3 is a sectioned view of FIG. 2;

FIG. 4 is an assembled perspective view of a liquid-containing ornament according to a second embodiment of the present invention;

FIG. 5 is a sectioned view of FIG. 4;

FIG. 6 is a sectioned view of a liquid-containing ornament according to a third embodiment of the present invention;

FIG. 7 is an assembled perspective view of a liquid-containing ornament according to a fourth embodiment of the present invention;

FIG. 8 is a sectioned view of FIG. 7;

FIG. 9 is a sectioned front view of a variant of the liquid-containing ornament of the present invention having vertically mounted rotating blades; and

FIG. 10 is a sectioned right side view of FIG. 9.

### DETAILED DESCRIPTION OF THE PREFERRED EMBODIMENTS

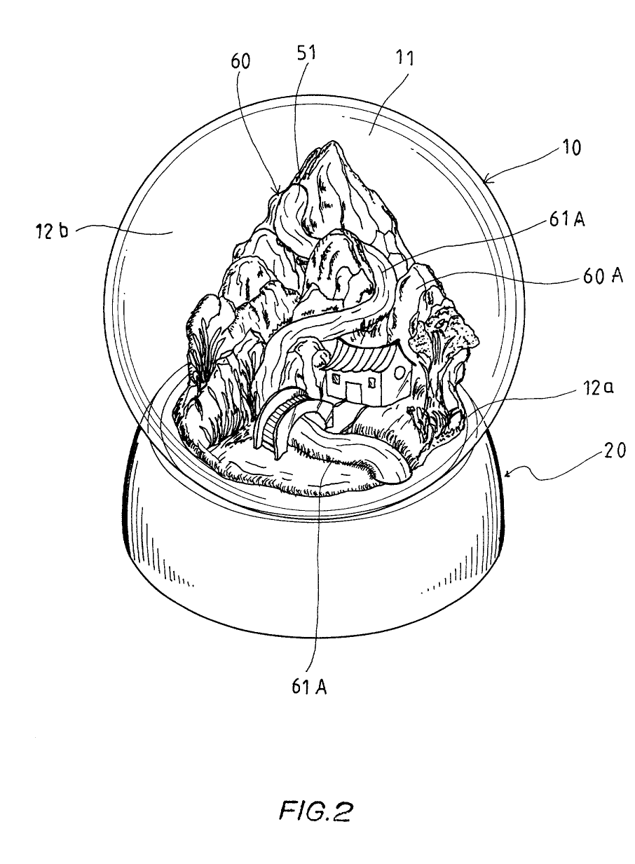

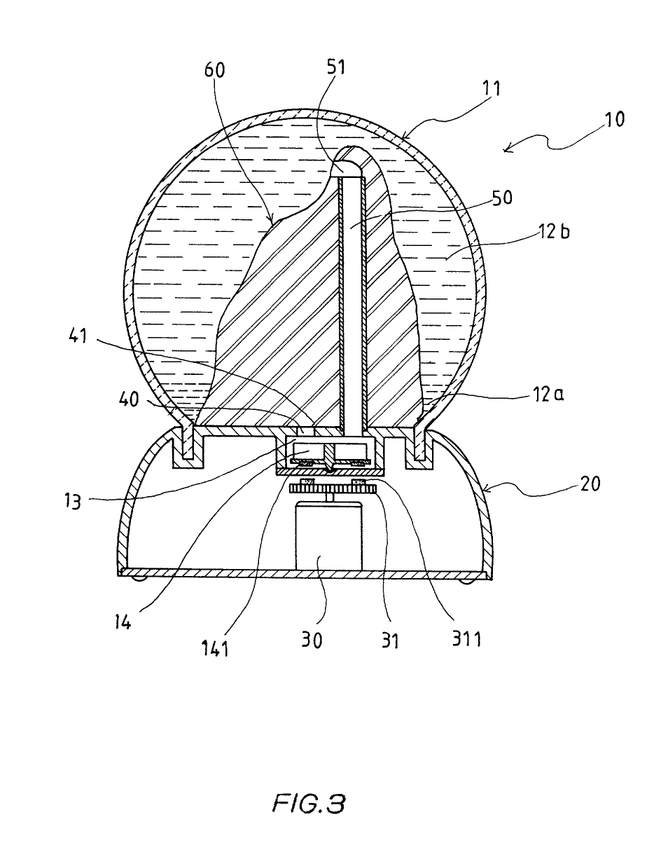

Please refer to FIGS. 2 and 3 that are assembled perspective and sectioned views, respectively, of a liquid-containing ornament according to a first embodiment of the present invention. As shown, the ornament generally includes an upper body 10 for showing dynamic scenes, and a base 20 for accommodating a driving mechanism therein.

The upper body 10 may be of any configuration without special limitation, but includes at least a container 11 made of a transparent material, so that an internal decoration 60 received in the container 11 could be seen from outside of the container 11. The container 11 may be a closed or an open container, and may be filled with either one single type of liquid 12a in the case of an open container, or two types of liquids, namely, a first and a second type of liquid, that have different densities and colors and are mutually indissoluble, such as water 12a and an oil 12b, respectively, in the case of a closed container. In the case of an open container 11, an outer cover may be provided to close the container 11. Wherein, the first liquid 12a has a specific gravity larger than that of the second liquid 12b and may be colored to contrast sharply with the second liquid 12b and create good display effect. For example, the water 12a may be blue and the oil 12b may be transparent. The container 11 communicates at a bottom surface with a chamber 13 located below it. A set of rotating blades 14 is horizontally mounted in the chamber 13, and each of the rotating blades 14 is provided at a lower side with a plurality of magnets 141. A motor 30 is mounted in the base 20 closely below the chamber 13 to rotate a rotary disc 31 located opposite to the set of rotating blades 14. The rotary disc 31 is provided at an upper side with a plurality of magnets 311 corresponding to and magnetically attracting the magnets 141 on the lower side of the rotating blades 14, so as to magnetically drives the rotating blades 14 to rotate along with the rotary disc 31 at the same speed.

The container 11 communicates with the chamber 13 via a liquid outlet tube 40 and a liquid inlet tube 50. The liquid outlet tube 40 has an outlet 41 located at a low position in the container 11. For example, the outlet 41 may be flush with an inner bottom surface of the container 11, so that the first type of liquid 12a, that is heavier than and locates below the second type of liquid 12b, automatically flows into the chamber 13 via the outlet 41. On the other hand, the liquid inlet tube 50 has an inlet 51 located at a high position in the container 11. The first type of liquid 12a in the chamber 13 is driven by the rotating blades 14 to flow through the liquid inlet tube 50 into the container 11 via the inlet 51. Due to its higher specific gravity, the first type of liquid 12a flown into the container 11 naturally flows toward the inner bottom surface of the container 11 to pass through the outlet 41 into the chamber 13 again, completing one cycle of circulation of liquid in the ornament of the present invention.

Differently designed internal decoration 60 may be provided within a path of the first type of liquid 12a flowing from the inlet 51 at the high position to the inner bottom surface of the container 11, so as to create dynamic scenes in the liquid-containing ornament. In the first embodiment of the present invention shown in FIGS. 2 and 3, the internal decoration 60 includes a landscape 60A showing hills, building, bridge, river 61A, etc. The colored first type of liquid 12a flows into the container 11 from the inlet 51 that is hidden below a top of the hills to wind among the hills along the river 61A until it reaches the outlet 41 that forms an end of the river 61A in the landscape 60A. The landscape 60A may be manually molded and colored to show a variety of unique appearances.

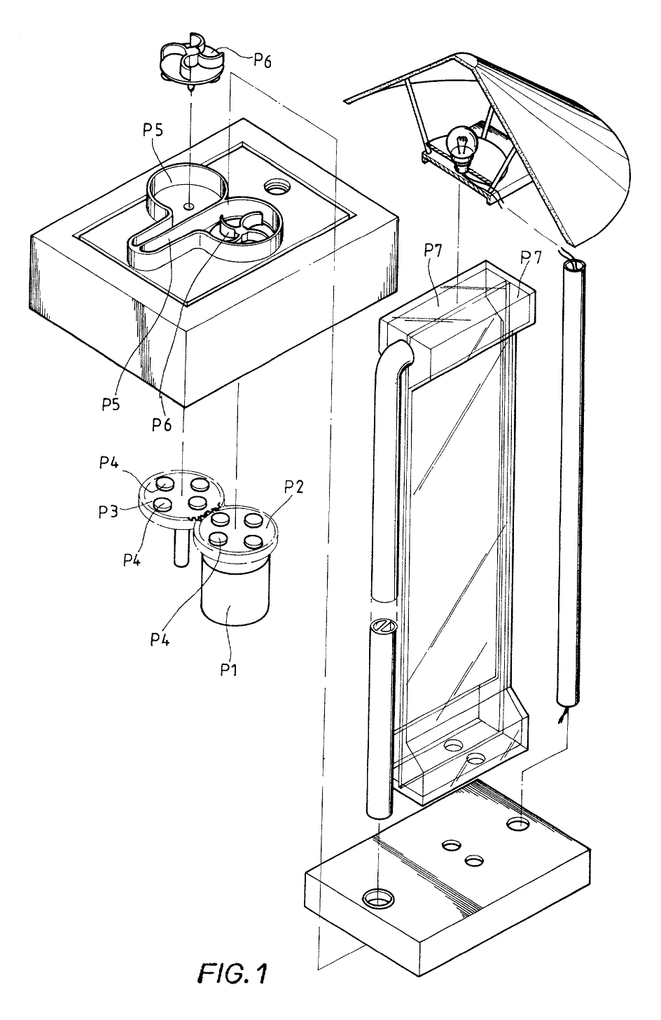

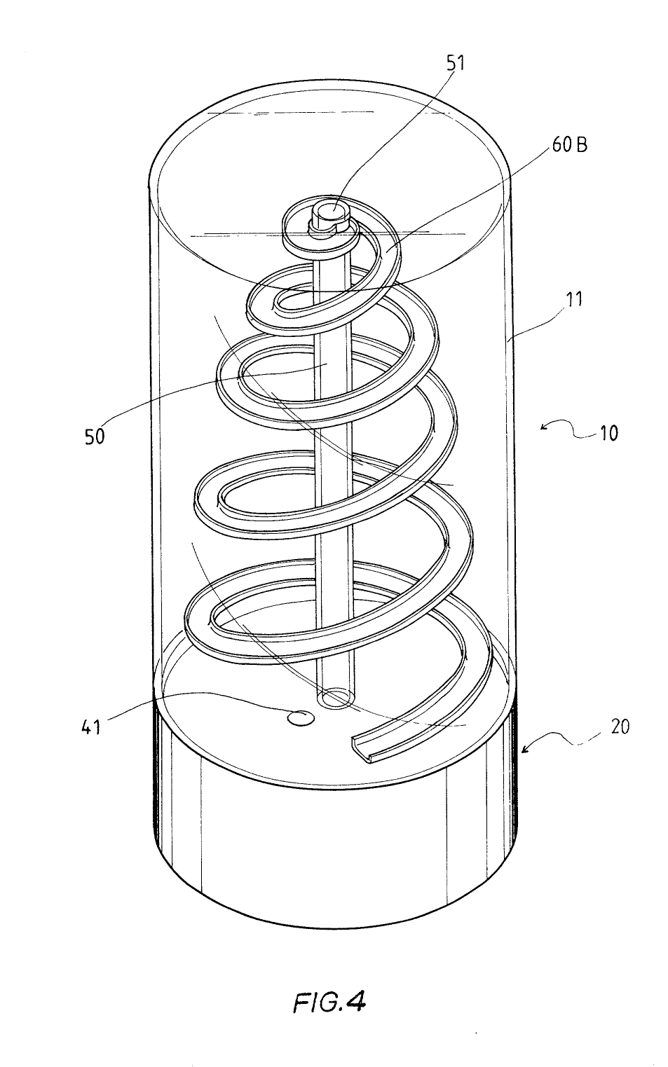

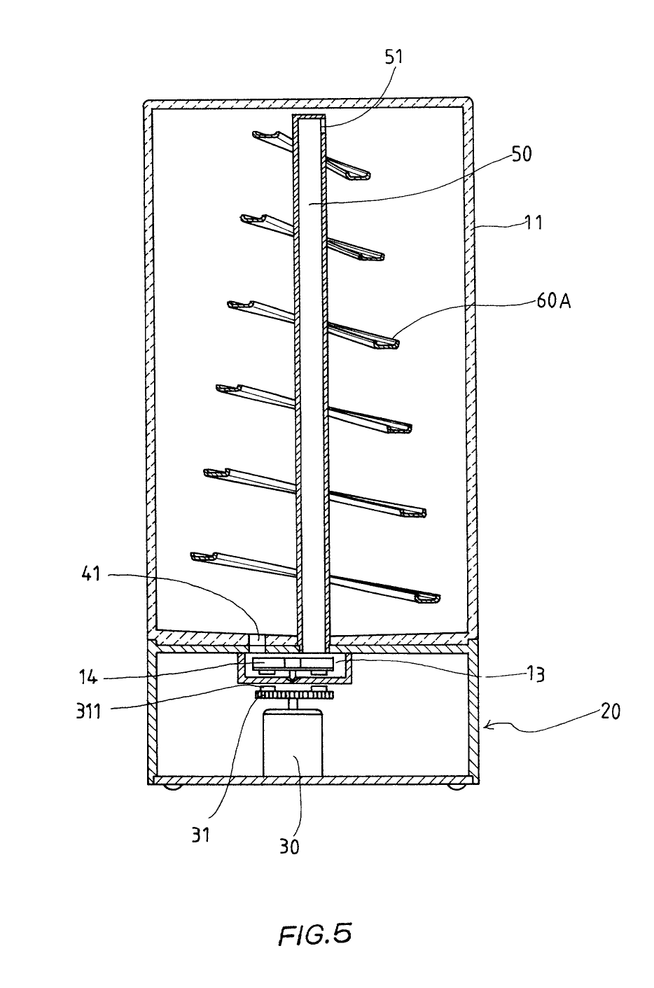

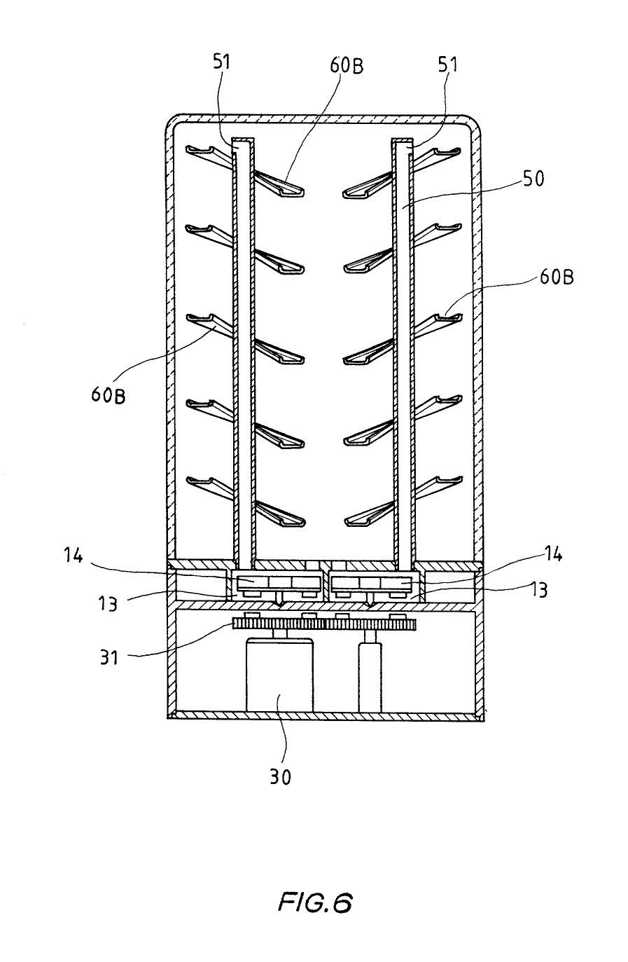

FIGS. 4 and 5 are perspective and sectioned views, respectively, of a liquid-containing ornament according to a second embodiment of the present invention. In the second embodiment, the internal decoration 60 includes a spiral chute 60B. The colored first type of liquid 12a enters the container 11 via the inlet 51 and forms a plurality of beads that sequentially flow down through the spiral chute 60B.

Where there is sufficient amount of liquid 12a in the container 11, the driving mechanism shown in FIG. 1 may be employed and two spiral chutes 60B may be provided in the container 11, as shown in FIG. 6, to provide a third embodiment of the present invention.

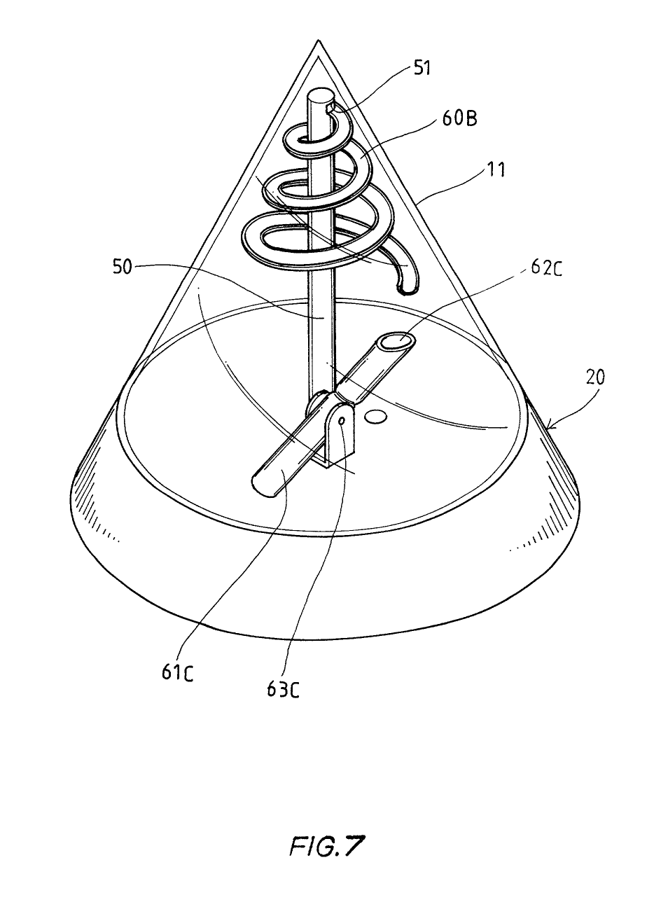

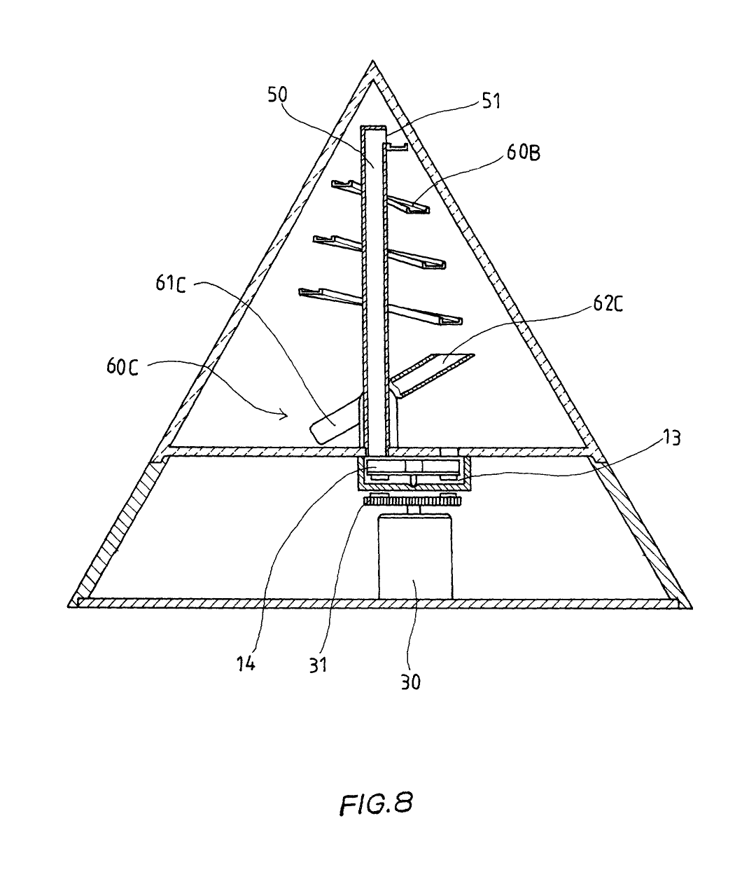

FIGS. 7 and 8 are perspective and sectioned views, respectively, of a liquid-containing ornament according to a fourth embodiment of the present invention. In the fourth embodiment, the internal decoration 60 includes a spiral chute 60B and a seesaw decoration 60C located below the spiral chute 60B. The seesaw decoration 60C includes a long receptacle 61C and a liquid chamber 62C provided at one side of the receptacle 61C to normally locate at a raised position. The liquid 12a enters the container 11 via the inlet 51 and passes the spiral chute 60B to drop into the liquid chamber 62C. The liquid 12a in the liquid chamber 62C causes the long receptacle 61C to turn about a supporting point 63C and gradually tilt toward the liquid chamber 62C. When the liquid chamber 62C is filled with a sufficient amount of the first type of liquid 12a, the long receptacle 61C is completely tilted to drain the liquid 12a in the liquid chamber 62C and then returns to an original position with the emptied liquid chamber 62C located at the raised position. The long receptacle 61C of the seesaw decoration 60C is repeatedly tilted in a reciprocating motion to show a dynamic scene in the ornament of the present invention.

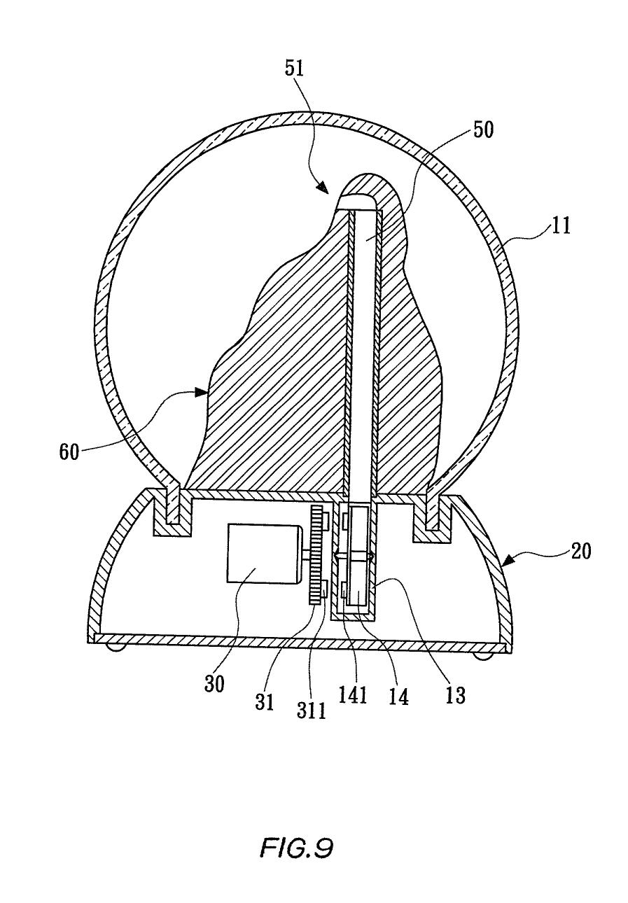

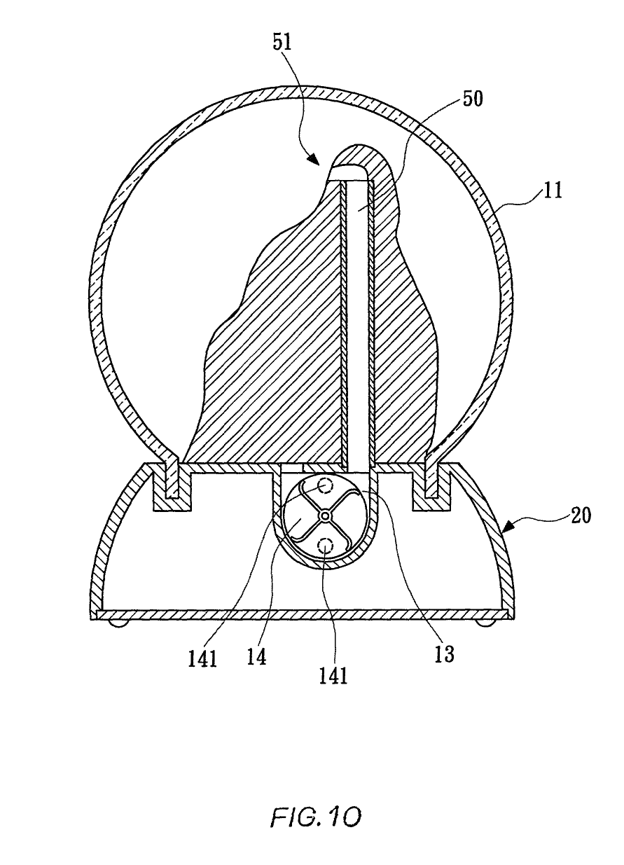

In the above-described embodiments, the set of rotating blades 14 is horizontally mounted in the chamber 13, as can be clearly seen from FIGS. 3, 5, 6 and 8. That is, a rotating shaft of the set of rotating blades 14 is in a vertical position in the chamber 13. However, the set of rotating blades 14 may be otherwise vertically mounted in the chamber 13, as shown in FIGS. 9 and 10. In this case, the motor 30 and the rotary disc 31 outside the chamber 13 are correspondingly changed in their mounting and rotating positions. That is, the motor 30 is located at one side of the chamber 13 and the rotary disc 31 is vertically rotatably located between the motor 30 and the set of blades 14. In this manner, the base 20 may be differently designed to show spatial changes for the ornament of the present invention to show different decorating effect. Moreover, lighting means may be provided at suitable positions to illuminate the container 11 via the transparent bottom surface of the container 11.

What is claimed is:

1. A liquid-containing ornament, comprising an upper body of any configuration for accommodating an amount of liquid and showing dynamic scenes, and a base for accommodating a driving mechanism therein; said upper body including at least a container 11 made of a transparent material, so that an internal decoration received in said container could be seen from outside of said container; said container communicating at a bottom surface with a chamber located below said container for a set of rotating blades to mount therein, each of said rotating blades being provided at one side with a plurality of magnets; said driving mechanism including a motor mounted in said base closely outside said chamber, and a rotary disc located outside said chamber opposite to said set of rotating blades and being driven to rotate by said motor, said rotary disc being provided at one side facing said rotating blades with a plurality of magnets to magnetically attract said magnets on said rotating blades and thereby magnetically drive said rotating blades to rotate along with said rotary disc at the same speed; said container communicating with said chamber via a liquid outlet tube having an outlet located at a low position in said container and a liquid inlet tube having an inlet located at a high position in said container; said liquid in said container automatically flowing into said chamber via said outlet of said liquid outlet tube and being driven by said set of rotating blades to flow through said liquid inlet tube into said container via said inlet; and said liquid entered said container naturally flowing downward into said chamber via said outlet again, completing one cycle of circulation of said liquid in said liquid-containing ornament.

2. The liquid-containing ornament as claimed in claim 1, wherein said container is a closed container.

3. The liquid-containing ornament as claimed in claim 1, wherein said container is an open container.

4. The liquid-containing ornament as claimed in claim 1, wherein said internal decoration provided in said container is located within a path along which said liquid flows from said inlet at said high position to said outlet at said low position in said container.

5. The liquid-containing ornament as claimed in claim 1, wherein said container has two different types of mutually indissoluble liquids accommodated therein, and said two types of liquids having different densities and colors.

6. The liquid-containing ornament as claimed in claim 1, wherein said container has one single type of liquid accommodated therein.

7. The liquid-containing ornament as claimed in claim 1, wherein said chamber and said set of rotating blades mounted therein are in a horizontally extended position, and said rotary disc located outside said chamber rotate in a horizontal plane corresponding to said chamber and said set of rotating blades.

8. The liquid-containing ornament as claimed in claim 1, wherein said chamber and said set of rotating blades mounted therein are in a vertically extended position, and said rotary disc located outside said chamber rotate in a vertical plane corresponding to said chamber and said set of rotating blades.
